(19) United States
(12) Patent Application Publication
(10) Pub. No.: US 2002/0156736 A1
(43) Pub. Date: Oct. 24, 2002

(54) Self-service terminal

(75) Inventors: James Piggot, Dundee (GB); Charles G.V. Rohan, Dundee (GB); Bart Grotegoed, Delft (NL); James S. Kirkhope, Perth (GB); Claire Shufflebotham, Perth (GB)

Correspondence Address: Michael Chan, Intellectual Property Section, Law Department, NCR Corporation, 1700 South Patterson Blvd., Dayton, OH, 45479-0001, US

(73) Assignee: NCR Corporation

(21) Appl. No.: 10/127,931

(22) Filed: Apr. 23, 2002

(30) Foreign Application Priority Data
Apr. 24, 2001 (GB) 0110083.3

(51) Int. Cl. G06F 17/60

(52) U.S. Cl. 705/43

(57) ABSTRACT

A self-service terminal (12) for soliciting non-transaction responses from a user is described. The terminal (12) may be part of a network (10), such as an ATM network, and comprises: a user interface (27), means for identifying a user (33), means for accessing a database (34) storing question profile data, means for determining whether an identified user is to be presented with a question (38); and means for updating the database in response to a user's response to a question (38). A network of self-service terminals and a method of operating a self-service terminal are also described.

### BACKGROUND OF THE INVENTION

The present invention relates to a self-service terminal (SST) and to a network of SSTs. In particular, the invention relates to an automated teller machine (ATM) for soliciting non-transaction responses.

ATMs are networked public access devices that are typically located in areas having high pedestrian traffic. ATMs are installed in a large number of countries world-wide and provide users with a convenient, secure, and reliable source of cash and other financial transactions and services. As a result of the ubiquity and convenience of ATMs, ATMs are able to reach a large number of people covering a wide range of social and demographic profiles.

For a user to be able to execute a transaction at an ATM, the ATM must identify the user, typically using an identification token (such as a card) together with a personal identification number (PIN). Once an ATM has identified the user that is entering a transaction, the ATM has access to some of that user's personal and financial information (via the financial institution with which the user has an account).

Despite ATMs interacting with so many different types of people, and knowing so much information about each ATM user, an ATM network does not take advantage of this by gathering non-transaction information from identified users. Typically, the only information gathered by an ATM relates to a transaction being entered by a user.

### SUMMARY OF THE INVENTION

It is among the objects of an embodiment of the present invention to obviate or mitigate the above disadvantage or other disadvantages associated with prior art SSTs.

According to a first aspect of the present invention there is provided a self-service terminal for soliciting non-transaction responses from a user, the terminal comprising a user interface, means for identifying a user, means for accessing a database storing question profile data, means for determining whether an identified user is to be presented with a question; and means for updating the database in response to a user's response to a question.

The question profile may comprise a plurality of questions, each question associated with a demographic profile (such as the age of an identified person), and/or a gender profile (male or female), and/or a location profile (the city or area in which the SST is located), or such like.

The questions may relate to goods, services, or marketing material that the user may wish to be notified about at some future time; for example, a user may be asked if he is willing to receive information about discounted tickets for a theatre performance.

The database may be local to the SST, or may be remote from the SST. The database may include data connections to one or more SSTs. The data connections may take the form of a wireless network link, communications cables, a telecommunications network, or the like.

Where a question relates to market research, the database may be updated to indicate that the user has responded to the question (to avoid the user being asked the question again) and to store the answer supplied by the user.

Where a question relates to permission marketing, the database may be updated to indicate whether the user wishes to receive further information or not, so that the user is only supplied with further information if he has indicated that he is willing to receive more information. The question may provide the user with a choice of a channel or channels through which the user is willing to receive information, for example, email, telephone, mail, or such like.

By virtue of this aspect of the invention, an SST is able to perform market research by asking a user a question. In addition, the SST is able to perform permission marketing, that is, the SST may ask the user a question relating to information about a product or service or marketing material that the user may be willing to receive by some other channel, such as by post.

If the SST is to be used to perform market research, then an institution owning the SST may conduct market research for a third party. Users may be selected to participate in the market research by virtue of where they live, what gender they are, what age they are, how much money they have in an account, or such like. Once a predetermined number of responses have been received, and/or a predetermined time period has elapsed, the market research survey may be stopped and the results collated and analyzed.

The database may include an application that determines whether an identified user matches a participant profile for the market research, so that an identified user is only asked a question if they meet the participant profile.

In some embodiments, multiple questions may be asked.

The SST may be an ATM, and the ATM may present the user with a question during a transaction (for example, while a cash withdrawal request is being authorized, or at the end of a transaction).

According to a second aspect of the present invention there is provided a method of conducting a survey, the method comprising the steps of: identifying a user at a self-service terminal (SST); retrieving details of the identified user from a database; comparing the retrieved details against a set of criteria for survey subjects; providing those users which meet a predetermined number of the criteria with a number of survey options; and detecting an option selected by the user.

According to a third aspect of the present invention there is provided a method of operating a survey, the method comprising the steps of: obtaining one or more survey questions from a third party; providing selected self-service terminal (SST) users with a selected survey question; detecting the user's responses to the survey question; and providing details of the responses to the third party.

The method may comprise the additional step of charging the third party for the provision of this method. Various charging schemes and tariffs will be readily apparent to those of skill in the art; for example, the third party may be charged a fixed fee for having the questions provided to users, or may be charged per user questioned, or per response received, or such like.

According to a fourth aspect of the present invention there is provided a method of conducting a survey using a self-service terminal (SST), the method comprising the steps of: presenting users of an SST with a plurality of choices, each representing a possible response to a survey question; detecting a choice selected by each user; and recording the number of users selecting each of said choices.

According to a fifth aspect of the present invention there is provided a network of self-service terminals, the network comprising: a database for storing user information; an interaction control manager; and a campaign control manager for storing questions to be posed to users; where the interaction control manager determines which questions are to be posed to which users, and stores responses received from the users.

The network preferably analyses and acts on the responses received from the users.

By virtue of this aspect of the invention, a network can control which terminals present which questions to which users, thereby allowing central control of a research or marketing campaign.

### BRIEF DESCRIPTION OF THE DRAWINGS

These and other aspects of the present invention will be apparent from the following specific description, given by way of example, with reference to the accompanying drawings, in which:

FIG. 1 is block diagram of a self-service terminal network according to one embodiment of the present invention;

FIG. 2 is a pictorial diagram showing a part (an SST) of the network of FIG. 1 in more detail;

FIG. 3 is a block diagram showing another part (the host) of the network of FIG. 1 in more detail;

FIG. 4 illustrates one example of an entry in a database stored in the host of FIG. 3;

FIG. 5 illustrates an example of a question table created in the host of FIG. 3 and referenced by the entry of FIG. 4;

FIG. 6 illustrates another example of an entry in a database stored in the host of FIG. 3; and

FIG. 7 illustrates another example of a question table created in the host of FIG. 3 and referenced by the entry of FIG. 6.

### DETAILED DESCRIPTION

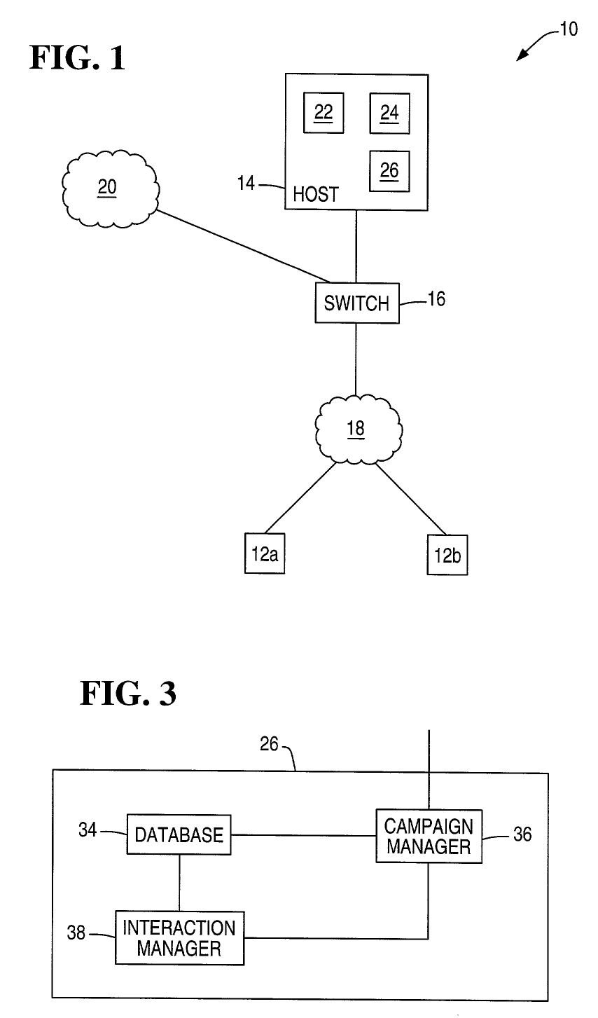

Reference is now made to FIG. 1, which is a simplified block diagram of an SST network 10, in the form of an ATM network, according to one embodiment of the present invention. The ATM network 10 is owned and operated by a financial institution, and comprises a plurality of ATMs 12 (only two of which are shown) connected to a host 14 via a transaction switch 16 and a secure network 18. The switch 16 is also connected to interchange networks 20 for authorizing transactions relating to accounts held with other institutions.

The host 14 includes a card services facility 22 for validating the claimed identity of a user at one of the ATMs 12, an account services facility 24 for authorizing transactions from an account held by an identified user, and a campaign management facility 26 for managing a permission marketing or market research campaign.

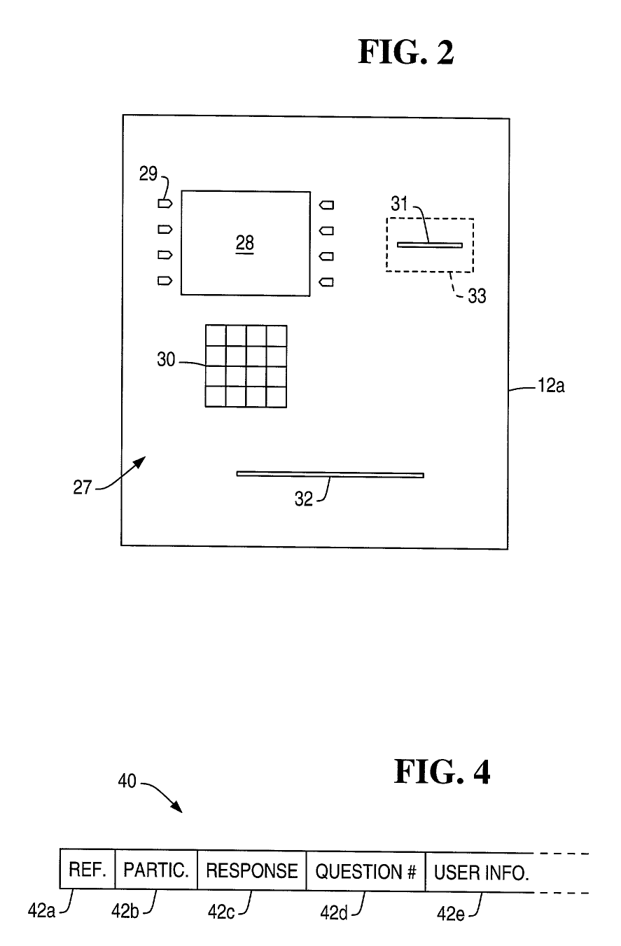

Reference is now made to FIG. 2, which is a pictorial view of ATM 12a. ATM 12a includes a user interface 27 comprising a display 28, function display keys (FDKs) 29 aligned as two columns, one column on either side of the display 28; an encrypting keypad 30, a card entry/exit slot 31, and a cash dispense slot 32. The card entry/exit slot 31 aligns with a motorized card reader/writer module (MCRW) 33 (shown in broken line) located within the ATM 12a. The ATM 12a also includes conventional modules, such as a cash dispenser, a network connection, a controller, and such like. None of these modules is shown in FIG. 2, and as these modules are well known to those of skill in the art they are not described herein.

Reference is now made to FIG. 3, which shows the campaign management facility 26 in more detail. The campaign management facility 26 comprises a user database 34, a campaign control manager 36, and an interaction control manager 38.

The user database 34 includes an entry for each of the financial institution's account holders who has an ATM card (that is, a card that can be used to withdraw funds using an ATM). A simplified entry is shown in FIG. 4. The entry 40 comprises a plurality of fields 42 including: a reference field 42a, a participation field 42b, a response field 42c, a question number field 42d, and additional user information fields 42e.

Reference field 42a includes a unique reference that associates a token presented by a user (such as the user's account number or card number) with the user's identity. The reference field 42a enables the database 34 to receive a claimed identity from an ATM 12 (which may be a user's account number from a magnetic stripe card inserted by the user) and to select the unique entry 40 in the database 34 associated with that claimed identity.

Participation field 42b indicates whether the user is a potential participant in a current campaign. This field 42b is updated when a new campaign is initiated.

Response field 42c indicates whether the user has provided a response for the current campaign. This prevents a user from being asked the same question twice.

Question number field 42d stores a pointer to the question or questions to be presented to the user. This field 42d facilitates mapping of questions to participants by referencing an entry in a question table (which will be described in more detail below).

User information field 42e (which may comprise a plurality of sub-fields) enables additional details about the user to be stored, such as the user's age, gender, and amount of funds held in the user's accounts, if the user is willing to allow the institution to store this information on the database 34.

The campaign control manager 36 interfaces to both the database 34 and the interaction control manager 38, and has a user interface to allow an authorized person from the financial institution to initiate a campaign. The campaign control manager 36 is a software application that prompts the authorized person to enter the following data.

Participant data. This details the criteria to be met for an ATM user to qualify as a participant in the campaign.

Question data. This relates to the question or questions that are to be asked to participants in the campaign.

Mapping data. This associates participants with questions, that is, which question is (or which questions are) to be asked to which participant.

Campaign termination data. This relates to when the campaign will cease, which may be after a predetermined amount of time has elapsed, when a predetermined number of participants have been questioned, when a predetermined number of responses have been received, or a combination of these.

The campaign control manager 36 uses this information to update the database 34. In particular, the campaign control manager 36 analyses the participant data to determine which users may participate in the campaign. For example, if the campaign seeks responses only from males, then every entry 40 associated with a female will have the participation field 42bupdated to reflect that that user is not a potential participant; similarly, every entry 40 associated with a male will have the participation field 42b updated to reflect that that user is a potential participant. It will be appreciated that the participation criteria may be based on any information stored in the database, such as demographics, age, or such like; or on information available to the ATM network 10, such as the geographical location of an ATM at which a transaction is being executed.

The campaign control manager 36 also resets the response field 42c for every entry in the database 34.

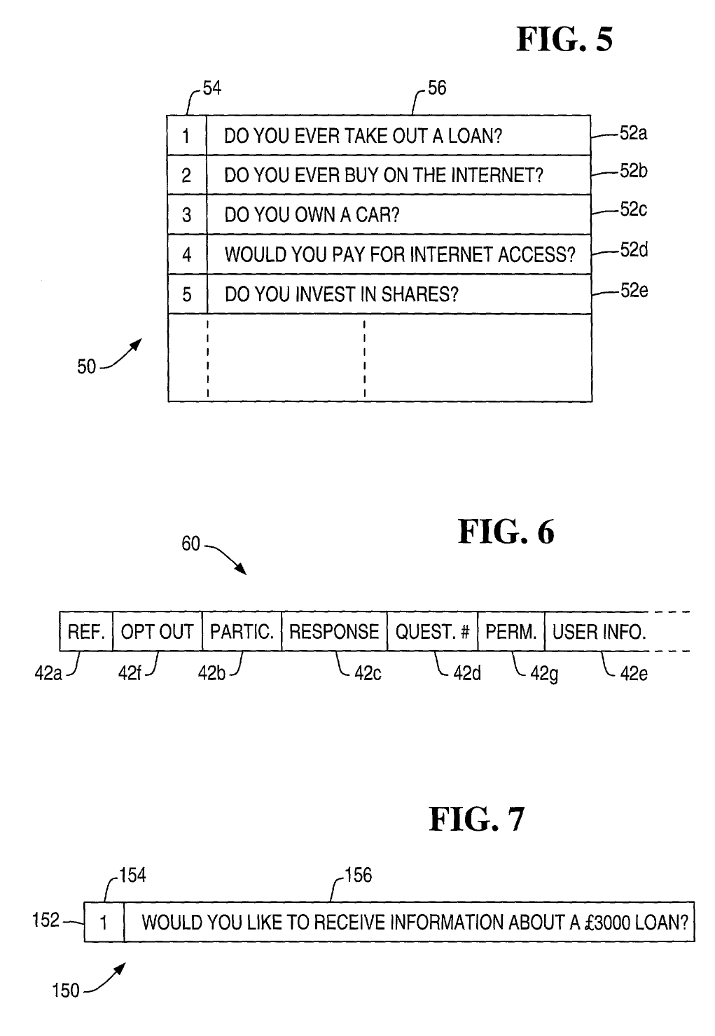

The campaign control manager 36 creates a question table, as illustrated in FIG. 5. The table 50 comprises a plurality of entries 52, each entry 52 having an identification field 54 (containing a question number) and a question field 56 (containing the text of a question to be asked).

For each potential participant, the campaign control manager 36 uses the mapping data to update the question number field 42d. Thus, if a potential participant is to be asked question number three (entry 52c) from the question table 50, then that participant's question number field 42d is updated to include a pointer to entry 52c in the question table 50.

An example of a transaction at ATM 12a by a potential participant in a market research campaign will now be described.

The user inserts his card into card slot 31 of the ATM 12a. The MCRW module 33 reads the user's card to obtain account information and conveys this account information to the interaction control manager 38. The ATM 12a proceeds with offering the user a transaction via the ATM's display 28 as normal.

The interaction control manager 38 accesses the database 34 to determine (from fields 42b and 42c) whether the user is a potential participant, and if so, whether he has already responded to a question. In this example the user is a potential participant who has not responded to a question.

The interaction control manager 38 then reads the question number pointer from field 42d (in this example it is question number two) and accesses the appropriate entry (entry 52b) from the question table 50.

The interaction control manager 38 then conveys this question to the ATM 12a, which presents this question to the user on display 28 in the “dead time” during which the ATM 12a is obtaining transaction authorization from the switch 16. The question can be answered either “yes” or “no” by pressing an appropriate key on the ATM's keypad 30 or FDK arrangement 29.

The user's response to this question (if the user does respond) is conveyed by the ATM 12a to the interaction control manager 38, which updates the response field 42c in the user's database entry 40, and stores the response. The response may be anonymized so that it cannot be associated with the user who provided the response; alternatively, the response may be stored as part of the user's entry 40, for example, in one of the user information sub-fields 42e.

In some embodiments, the question number field 42d may contain a plurality of pointers (question numbers) so that on each visit to an ATM 12, the user is asked a different question, until all of the questions have been asked. Once a question has been asked, its pointer may be deleted from the question number field 42d. Thus, the interaction control manager 38 may manage presentation of a plurality of questions to a user over a period of time, but avoid asking more than one question on each visit to an ATM. In some embodiments, the interaction control manager 38 may only ask a question once for each predetermined number of visits to an ATM, for example, once every three visits.

The interaction control manager 38 tracks the number of questions asked, the number of questions answered, and the time elapsed since the current campaign started, and compares this with the campaign termination data to determine when the current campaign should be terminated.

As the campaign progresses, the authorized person is able to monitor the data tracked by the interaction control manager 38 via the campaign control manager 36.

When the campaign has been terminated, the campaign control manager 36 is provided with all of the data collated relating to the campaign, such as the number of participants questioned, the number of participants who responded, the responses given, and such like. This collated data may be used in deciding what products or services the financial institution (or a third party who requested the financial institution to initiate this campaign) may wish to introduce.

In another example, a campaign may relate to permission marketing. FIG. 6 shows an entry 60 having all of the fields of the entry 40 of FIG. 4, and some additional fields. It will be appreciated by those of skill in the art that a database entry, such as entry 40 and entry 60, may have a large number of fields; for clarity, only those fields relevant to the examples given are shown in FIGS. 4 and 6. The additional fields in FIG. 6 are an opt out field 42f and a permission field 42g.

The opt out field 42f is set when a user indicates that he/she does not wish to be part of any campaign at any time. If the opt out field 42f is set, then the interaction control manager 38 will not regard the user as a potential participant, and the user will not be asked any non-transaction related questions at an ATM (that is, any questions that do not relate to a transaction being executed or about to be executed on the ATM). It will be appreciated that the opt out field could also have been used in the previous example (relating to a market research campaign).

The permission field 42g contains a reference to any materials (such as goods, products, services, advertisements, coupons, vouchers, or such like) that the user is willing to receive information about. Initially, this field 42g is blank.

A typical permission marketing example will now be described.

Initially, the financial institution may determine what products or services it wishes to market (for example, a £3000 loan). An authorized person from the fmancial institution then uses the campaign control manager 36 to enter participant data, question data, mapping data, and campaign termination data. In this example, the question data relates to whether the user is willing to receive information relating to a £3000 loan, and may also request the user to select from a list of channels through which the information may be delivered.

As in the previous example, the campaign control manager 36 uses this information to update the database 34. Potential participants are only those who have not opted out of campaigns (field 42f) and who match the participant data entered by the authorized person (which is the profile of ATM users who may wish to be notified about special offers relating to a £3000 loan). In this example, the mapping data is simple because each person is asked the same question; thus, the question table 150 (FIG. 7) contains just one entry 152, and field 42d in the entry of every potential participant contains a pointer to this one entry 152 in the question table 150. The entry 150 has an identification field 154 containing a question number (in this example “1 ”) and a question field 156 containing the text of a question to be asked (in this example “Would you like to receive information about a £3000 loan?”).

When a user who is a potential participant wishes to execute a transaction at an ATM 12, the user inserts his card into the card entry slot 31 of ATM 12. The MCRW module 33 reads the user's card to obtain account information and conveys this account information to the interaction control manager 38. The ATM 12a proceeds with offering the user a transaction as normal.

The interaction control manager 38 accesses the database 34 to determine (from fields 42b, 42c, and 42f) whether the user is a potential participant, has not opted out, and has not already responded to a question. In this example the user is a potential participant who has not opted out and not has responded to a question.

The interaction control manager 38 then reads the question number pointer from field 42d (in this example the question number pointer is “1”) and accesses the entry in question table 150 that is pointed at by field 42d (entry 152).

The interaction control manager 38 then conveys this question to the ATM 12a, which presents this question to the user during the “dead time” when the ATM 12a obtains transaction authorization from the switch 16. The question can be answered either “yes” or “no” by pressing an appropriate key on the ATM's keypad 30 or FDK arrangement 29.

The user's response to this question (if the user does respond) is conveyed by the ATM 12a to the interaction control manager 38, which updates the response field 42c and the permission field 42g in the user's database entry 60. The response field 42c now indicates that the user has responded, and the permission field 42g now indicates whether the user is willing to receive information about a £3000 loan.

In some embodiments, the question number field 42d may contain a plurality of pointers (question numbers) so that on each visit to an ATM 12, the user is asked a different question, until all of the questions have been asked. Once a question has been asked, its pointer may be deleted from the question number field 42d. Thus, the interaction control manager 38 may manage asking a plurality of questions to a user over a period of time, but avoid asking more than one question on each visit to an ATM.

The permission field 42g may store the user's response to a plurality of different permission marketing questions.

The interaction control manager 38 tracks the number of questions asked, the number of questions answered, and the time elapsed since the current campaign started, and compares this with the campaign termination data to determine when the current campaign should be terminated.

As the campaign progresses, the authorized person is able to monitor the data tracked by the interaction control manager 38 via the campaign control manager 36.

When the campaign has been terminated, the campaign control manager 36 is provided with all of the data collated relating to the campaign, such as the number of participants questioned, the number of participants who responded, the responses given, and such like. This collated data is used for targeting advertisements for a £3000 loan to users who have expressed a willingness to receive information relating to a £3000 loan. It is anticipated that the questions asked in a permission marketing campaign will be directed to specific products or services to allow automatic targeting of these products or services to users.

Another example will now be outlined in terms of a market research survey comprising three questions. In this example, a double glazing company wishes to ask homeowners about their home insulation and energy use. The double glazing company pays the ATM operator in return for putting the questions to ATM users for a period of time, for example two weeks.

The survey questions are recorded in a question table (similar to tables 50 and 150), and potential participants are identified as those users who own a home.

When a user approaches the ATM 12 with a view to conducting a transaction, they insert their card into the ATM 12 as normal. User identification details (such as the user's account number) are then passed to the interaction control manager 38, where they are used to access the user's entry in the database 34 (as previously described). If the database 34 shows that the user is a potential participant who has not yet participated in the poll, the interaction control manager 38 sends the survey questions from the database 34 to the ATM 12.

The ATM 12 asks the user, via the display 28, whether he or she wishes to participate in the survey. Some financial or other incentive may be offered to entice users to participate. The user is able to respond by pressing one FDK representing “yes” or a different FDK representing “no”.

If the user responds with “no”, this information is passed on to the database 34 and the user's database entry is updated to indicate that this user does not wish to participate in this survey. This may be implemented, for example, by setting the response field to indicate that a response has been received, but more preferably, by setting the opt out field 42f, or one of the user information sub-fields 42e to indicate that the user did not wish to participate in the survey.

If the user agrees to participate, the questions are presented on the ATM display 28, and responses are obtained via the FDKs 29. Once the survey at the ATM 12 is over (that is, once the user has been asked the three questions), the user's answers are uploaded to the interaction control manager 38, where they are recorded, and the user's participation field 42bis updated to indicate that they have participated in this survey. The user's transaction then proceeds as normal.

At the end of the two-week period, the results of the survey are given to the double glazing company, and the survey questions removed from the question table.

Multiple surveys may take place simultaneously, with different sets of questions being asked of different user groupings, or with users being asked different questions on different visits to the ATM.

Certain embodiments of the invention may be arranged to ask questions only at particular times; for example, questions may not be asked during periods of peak use of the ATM, either at predetermined times or as determined from the number of transactions taking place at a particular time. This can assist in reducing user frustration by reducing the likelihood of queues forming as users participate in a survey.

Even though a market research example, a permission marketing example, and a survey example were described separately above, it will be appreciated that a network can conduct these campaigns simultaneously, as they are all implemented by a database entry that accesses a question table.

It will now be appreciated that the above examples have a number of advantages.

The market research examples have advantages over traditional market research because conducting market research using traditional methods is costly and problematic, and it is also difficult to identify a relevant sample of participants so that a valid result is obtained. In addition, conducting market research is generally labor intensive, particularly if the participants are spread over a large geographical area. These traditional problems are overcome by utilizing an ATM infrastructure to conduct market research. The ATMs in a network are linked to a database or data warehouse containing the profiles of all those who have accounts with the financial institution owning the ATM network. Users of an ATM may be asked whether they are willing to take part in market research, and may be offered some incentive to accept (for example, they may receive loyalty points, reduced bank charges, or some financial reward credited to their account). The institution owning the ATM network may provide this service to market research companies for a fee.

One advantage of using an ATM network is that a user's profile is known (from the database or data warehouse). This makes it easy to select the correct criteria for participants in the survey. For example, the survey may select participants according to demographics (people who live in a city center, or in a rural location), income (only people having an income exceeding a certain amount or below a certain amount), age (16 to 21 years olds, over 60's, etc.), ATM usage behavior (more than twice a week), by location (city center, travel overseas) or such like.

Another advantage of using an ATM network is that the questions can be asked automatically (with no human operator), and the answers can all be collated automatically, thus ensuring that the survey is not labor intensive to perform, even if the participants are spread over a large geographical area.

The permission marketing example has advantages in that many people do not like receiving advertisements or marketing material relating to products or services they have no interest in. People also like to ensure that any personal information relating to their purchasing habits, age, and such like, is not used without their consent. This makes it difficult to target marketing material to individuals.

By utilizing an ATM infrastructure, the ATMs in a network are linked to a database or data warehouse, and users of an ATM are asked whether they wish to receive specific information, products, or services. Thus, the ATMs seek permission from the users to market material to the users. If a user agrees to this, then at some subsequent time, when an offer becomes available, the user is notified of the offer.

An advantage of automating permission marketing via an SST network is that users can be targeted without the user feeling that their privacy is being violated because the user remains in control of:

(1) what marketing material is sent to the user, and

(2) what channels are used to send the marketing material.

Another advantage is that a financial institution owning an ATM network can generate revenue from that network by marketing information to individuals who want to receive that information.

Various modifications may be made to the above described embodiment within the scope of the invention, for example, in other embodiments, the campaign management facility 26 may be not be located in the host 14. In other embodiments a data warehouse may be used instead of a database. The data warehouse may include details of a user's lifestyle, and may be able to predict using these lifestyle details what type of goods or services a user may wish to be notified about.

In other embodiments, a standard permission marketing message may be presented to all ATM users who have not opted out, rather than a targeted message being presented to only those users that match a particular profile.

In other permission marketing campaigns, multiple campaigns may be run simultaneously, so that the mapping data maps potential participants with suitable permission questions (that is, questions relating to products or services suited to that potential participant).

In other embodiments, the question asked may restrict the marketing information supplied to one channel, for example, “Are you willing to receive at an ATM marketing material relating to cinema tickets?”. This re-assures the user that no marketing material will be posted to them or sent by email.

In other embodiments, the terminal may be a non-cash kiosk rather than an ATM.

What is claimed is:

1. A self-service terminal for soliciting non-transaction responses from a user, the terminal comprising:
a user interface;
means for identifying a user;
means for accessing a database storing question profile data;
means for determining whether an identified user is to be presented with a question; and
means for updating the database in response to a user's response to a question.

2. A terminal according to claim 1, wherein the database includes an application that determines whether an identified user matches a participant profile, so that an identified user is only asked a question if they meet the participant profile.

3. A terminal according to claim 1, wherein multiple questions are presented to each user.

4. An automated teller machine (ATM) comprising:
means for identifying an ATM customer;
means for accessing stored question profile data;
means for determining whether an identified ATM customer is to be presented with a question; and
means for updating stored question profile data when an identified ATM customer responds to a question presented to the identified ATM customer.

5. An ATM according to claim 4, further comprising means for presenting an identified ATM customer with a question during an ATM transaction.

6. An ATM according to claim 4, wherein the determining means includes means for determining whether an identified ATM customer matches a participant profile such that the identified ATM customer is asked a question only if the identified ATM customer matches the participant profile.

7. An ATM according to claim 4, wherein multiple questions are presented to an identified ATM customer.

8. A method of operating a self-service terminal, the method comprising the steps of:
obtaining one or more survey questions from a third party;
providing selected self-service terminal users with a selected survey question via the self-service terminal;
detecting the users' responses to the survey question; and
providing details of the responses to the third party.

9. A method according to claim 8, further comprising the step of:
charging the third party for the provision of the survey.

10. A method of operating an automated teller machine (ATM), the method comprising the steps of:
presenting selected ATM customers with at least one selected survey question obtained from a third party; and
receiving from selected ATM customers responses to a selected survey question presented to the selected ATM customers.

11. A method according to claim 10, further comprising the steps of:
providing to a third party details of responses to a selected survey question; and
charging a third party for providing to the third party details of responses to a selected survey question.

12. A network of self-service terminals, the network comprising:
a database for storing user information;
an interaction control manager; and
a campaign control manager for storing questions to be posed to users,
wherein the interaction control manager determines which questions are to be posed to which users, and stores responses received from the users.

13. A self-service terminal comprising:
means for identifying a user;
means for accessing question profile data based upon identity of a user;
means for determining if an identified user is to be presented with a question based upon accessed question profile data; and
means for presenting a question to an identified user when a determination is made that the question is to be presented to the identified user.

14. A self-service terminal according to claim 13, further comprising means for determining whether an identified user matches a participant profile such that the identified user is asked a question only if the identified user matches the participant profile.

15. A self-service terminal according to claim 13, wherein the presenting means includes means for presenting an identified user with a question during a transaction.

16. A method of operating a self-service terminal, the method comprising the steps of:
identifying a user;
accessing question profile data based upon identity of a user;
determining if an identified user is to be presented with a question based upon accessed question profile data; and
presenting a question to an identified user when a determination is made that the question is to be presented to the identified user.

17. A method according to claim 16, further comprising the step of:
determining whether an identified user matches a participant profile such that the identified user is asked a question only if the identified user matches the participant profile.

18. A method according to claim 16, wherein the step of presenting includes the step of:
presenting an identified user with a question during a transaction.

19. A self-service terminal comprising:
means for receiving inputs from a user;
means for processing a transaction based upon inputs received from a user; and
means for presenting at least one survey question to a user while the user is carrying out a transaction.

20. A method of operating a self-service terminal, the method comprising the steps of:
receiving inputs from a customer carrying out a transaction at the self-service terminal; and
presenting at least one survey question to a user while the user is carrying out a transaction at the self-service terminal.

21. An automated teller machine (ATM) comprising:
means for receiving inputs from an ATM customer;
means for dispensing currency to an ATM customer;
means for controlling the dispensing means to dispense currency to an ATM customer based upon inputs received from the ATM customer; and
means for presenting at least one survey question to an ATM customer while the dispensing means is dispensing currency to the ATM customer.

22. A method of operating an automated teller machine (ATM), the method comprising the steps of:
receiving inputs from an ATM customer carrying out a transaction at the self-service terminal;
dispensing currency to an ATM customer based upon inputs received from the ATM customer; and
presenting at least one survey question to an ATM customer user while currency is being dispensed to the ATM customer.
